(19) United States
(12) Patent Application Publication
(10) Pub. No.: US 2002/0198859 A1
(43) Pub. Date: Dec. 26, 2002

(54) Method and system for providing web links

(75) Inventors: David S. Singer, Los Gatos, CA (US); Edith H. Stern, Yorktown Heights, NY (US); Barry E. Willner, Briarcliff Manor, NY (US)

Correspondence Address: Louis J. Percello, IBM Corporation, P.O. Box 218, Yorktown Heights, NY, 10598, US

(73) Assignee: International Business Machines Corporation, Armonk, NY (US)

(21) Appl. No.: 09/887,739

(22) Filed: Jun. 22, 2001

(51) Int. Cl. G06F 7/00

(52) U.S. Cl. 707/1

(57) ABSTRACT

A system and method for providing web links based on the content of text to thereby create a web site with appropriate web links (hot links) imbedded in the web site. An application program reviews the text of the web site, preferably during the process of creating HTML code and determines and displays possible hot links which can be embedded into the application for an individual such as the web site creator to determine whether or not to include a hot link as suggested by the application. Several different hot links may be determined which are appropriate and one or more may be inserted into the application. Links are created based on capitalization, a corporation-indicating word and/or trademark or trade name indication, either alone or based on historical information of past web site links or text for which no web site was used.

### CROSS REFERENCE TO RELATED PATENT

The present invention is related to the following document which is specifically incorporated herein by reference:

U.S. Pat. No. 5,794,257 issued Aug. 11, 1998 to P. Liu et al. and entitled “Automatic Hyperlinking on Multimedia by Compiling Link Specifications”, assigned to Siemens Corporate Research, Inc. This patent is sometimes referred to as the Hyperlinking Patent.

### BACKGROUND OF THE INVENTION

1. Field of the Invention

The present invention relates to editing text to create a web site, complete with appropriate hot links to other web sites and an application program which assists in the accomplishment of the creation of the web site. More particularly, the present invention is a method and system which uses an editor to identify hot link candidates for inclusions as links and, based on input from the designer, including an appropriate link within code for creating the web site.

2. Background Art

Creating a web site has been a slow and very manual process in the past, where the creator designs the content and then manually locates any associated web sites and codes in the Universal Resource Locator (URL) address of the associated web site to include an appropriate hot link to the site using hypertext markup language (HTML) as a programming tool to create the web site with links to associated sites.

While some tools are available to make the creation and design of the web site easier and more efficient, these tools are generally directed to creating or inserting graphics and animation for a web site and not for creating the content, particularly the links to associated web sites. Of course, a key portion of any web design is ease of use and links to appropriate related web sites to allow the user to find easily and quickly material which is related to the content of the web site.

Such links to other sites in the prior art result either from another site providing a prompt to facilitate the inclusion of the link or because the designer knew of an associated web site.

The Hyperlinking Patent referenced above describes a system in which hyperlinks are inserted in manuals to provide linkages between related manuals using a link generator, a link verifier and a link inserter. This system in the Hyperlinking Patent uses links which are specified by the user and not links which are found by the system. In this sense, the Hyperlinking Patent relies on the user to provide the associated links.

Hyperlink generation for text generation was described in a project proposal by Architecture Technology Corporation and is available for reference on the Internet at http://www.atcorp.com/research/phase1/hypertxt/. This project was directed to providing links between related documents held on a single set of servers and not to finding related links on the Internet.

In addition, Microsoft has proposed “Smart Tags” which allows a user to register a DLL to scan text and create actions (including creation of likely links) based on what text gets typed, but such a system is not seen to identify anchor candidates or suggest links to web links automatically. See, for example, http://msdn.microsoft.com/voices/office06072001.asp and http://msdn.microsoft.com/library/techart/ODC_smarttags.htm for information on “smart tags”.

Accordingly, prior art systems relating to including hyperlinks have undesirable disadvantages and limitations which will be apparent to those skilled in the art in view of the following description of the present invention.

### SUMMARY OF THE INVENTION

The present invention overcomes the disadvantages and limitations of the prior art systems by providing a simple, yet effective, method and system for creating a web site from a text including links to related web sites.

The present invention includes parsing the text to identify candidates for including a hot link to another web site based on various clues in the text or from historical materials associated with the software. These candidates are sometimes referred to as “anchor candidates” in this document and result from some indication (often in the text of a web site) that a related web site may be invoked or from some history on the subject associated with the software. Then, when one or more web sites have been identified as being of possible relevance, the preferred system of the present invention involves a designer or user reviewing the anchor candidates and deciding whether to include a hot link to such other web site. When multiple web sites have been identified, the user or designer may select which one of the sites will be used as a hot link, or that an option may be presented to link to different web sites depending on the desires of the end user.

The present invention includes, as an optional adjunct, a system for storing past histories from the creation of earlier web sites so that the parsing of the next set of text may build upon the past history of building sites. That is, links which had been included previously for a given word can be reused and/or anchor candidates which had deliberately not been linked to web sites on previous occurrences may be passed over again, if desired. That is, the processing of an anchor candidate may rely on past history and include the same links as had been previously used for the same anchor candidate.

The present invention includes a parsing system which identifies anchor candidates using the appearance of a word through various clues, including capitalization, “corporation” indicators in the vicinity and locating words which do not appear in a conventional dictionary, indicating that they are potential trade names or trademarks. Additionally, the inclusion of brand-name indicators such as “trademark” and “registered” indicates that the preceding term may be a trademark, which in turn, indicates that a web page may exist which is related to the term. An optional list of known trademarks may be employed to advantage to identify trademarks which are anchor candidates in a system of the present invention.

In its preferred embodiment of the present invention during the design stage, the present invention highlights anchor candidates using a suitable marker (which might be much like spell checking software highlights words which may be misspelled). Then, a cursor is advanced from one highlighted anchor candidate to the next, allowing the designer, in the preferred embodiment, to either select to have a web site correlated with the anchor candidate or not, and, if multiple web sites are identified, to choose which web site to correlate.

Alternatively, a designer may select to have all of the web sites included, making this an automated system for including web site links without human intervention, if that level of automation is desired in creating software for a web site. Of course, such an automated system of including hot links would have the possibility of including erroneous links (to, for example, the wrong Universal company when Universal Music, Universal Films and Universal Moving and Storage all may have sites and the system might not know which site to reference when locating a reference to Universal.) Presumably, a user of the system would at least recognize when an incorrect site is referenced and ignore a link to an unrelated site or, preferably, include a link to the correct site.

The present invention also includes software including web sites references (or hot links, in an HTML programming language) created as a result of the use of the present invention. That is, the present invention is a novel method and system for creating application software which provides hot links to web sites and envisions that the creation of new and improved web sites allowing for the end user to see multiple hot links for a given link and to select one of the plurality of hot links for use at any given time and allowing for subsequent use of another hot link at another time.

It should be recognized that a system which looks for words which are not in the dictionary is likely to find a misspelled word as not being in the dictionary. In such a case it is likely that no web site matches will be located for such a misspelled word, and, even if a site is found which matches the misspelled word, a reviewer should recognize that the word is misspelled when it is identified as a possible anchor candidate.

Other objects and advantages of the system and method of the present invention will be apparent to those skilled in the relevant art, in view of the following description of the preferred embodiment, taken together with the accompanying drawings and the appended claims.

### BRIEF DESCRIPTION OF THE DRAWINGS

Having thus described some of the objects and advantages of the present invention, other objects and advantages will be apparent to those skilled in the art in view of the following description of the invention taken in conjunction with the accompanying drawings in which:

FIG. 1 is an illustration of a selection of text (a portion of the content for a proposed web site) as it is originally created;

FIG. 2 is an illustration of the selection of text for the proposed web site of FIG. 1 with the addition of highlighting to indicate anchor candidates;

FIG. 3 is an illustration of the web site of FIG. 2 with highlighted anchor candidates when a reviewer is reviewing one of the highlighted anchor candidates;

FIG. 4 is a block diagram of the present invention;

FIG. 5 is a flow chart of the parser of the present invention;

FIG. 6 is a flow chart for the system of the present invention and one method of practicing the present invention; and

FIG. 7 is an illustration of one of the tables useful in practicing the present invention.

### DETAILED DESCRIPTION OF THE PREFERRED EMBODIMENT

In the following description of the preferred embodiment, the best implementation of practicing the invention presently known to the inventor will be described with some particularity. However, this description is intended as a broad, general teaching of the concepts of the present invention using several specific embodiments but is not intended to be limiting the present invention to that as shown in these embodiments, especially since those skilled in the relevant art will recognize many variations and changes to the specific structure and operation shown and described with respect to these figures.

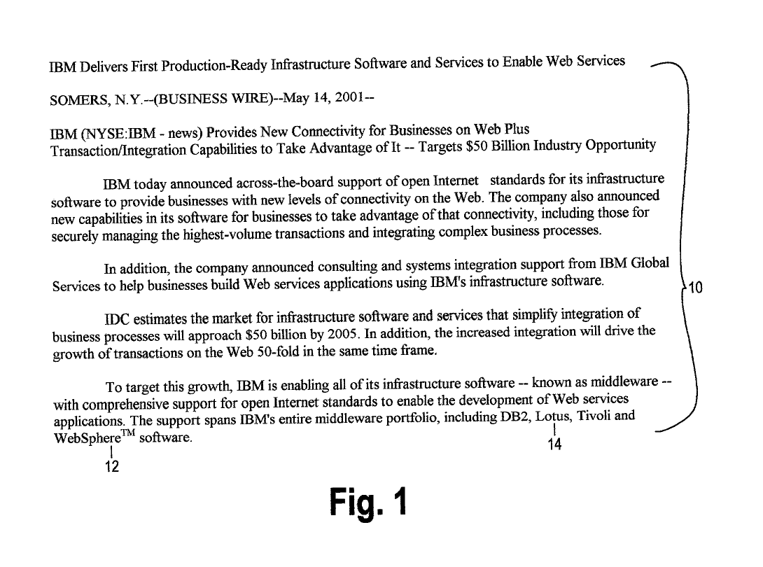

FIG. 1 illustrates a sample portion 10 of text of the type which might be used in creating a web site. This sample portion 10 of text includes a paragraph about a product and includes some words which are ordinary words of the type which may be found in a conventional dictionary (either directly or in a slightly-modified and predictable form, as where an “s”, “'s”, “ing” or “ed” has been added to the dictionary word to form a plural, a possessive, a gerund or a past tense, respectively). The ordinary words are of little interest to a web site creator in that these words are less likely to be words for which a web site exists.

In addition to the ordinary dictionary words (or predictable modifications thereof), the sample portion 10 of text includes a word 12 which is marked by a superscript “TM” indicating that the preceding word is a trademark, a capitalized word 14, a multi-word name 16 of a corporation which includes one of the several words (“corporation” in this case) and abbreviations which are used in the United States to identify corporation names (other corporation-identfying words in the United States include one of the words or abbreviations “Incorporated”, “Company”, “LLC”, “Inc.”, “Co.” and “Corp.”) but which may vary from one country to the next (one country may use “Limited” and another may use “Gmb.H.” or “S.A.”, for example.)

Other variations of common words could be recognized using either a dictionary plus a set of rules or an “augmented” dictionary, if desired. The dictionary can be augmented with various forms of words, such as variations on plurals and possessives (where “es” may be added to a base verb or where different forms of irregular verbs are included as separate entries in the dictionary (such as “seen” and “went” as verb forms of “see” and “go”). The important step in using a dictionary is to identify those words which are in common usage from those which are not in common usage, for the words which are not in common usage are more likely to be coined and useful as hot links to information at a web site.

The purpose of reviewing the text is to determine possible hot links (sometimes referred to as anchor candidates in this document). These anchor candidates are words or phrases which are either not in the dictionary or are identifiable as a possible trademark or corporate name or are includes in a historical list of hot links. These anchor candidates are words or phrases which have a likelihood of being used as hot links within text to provide links to other web sites.

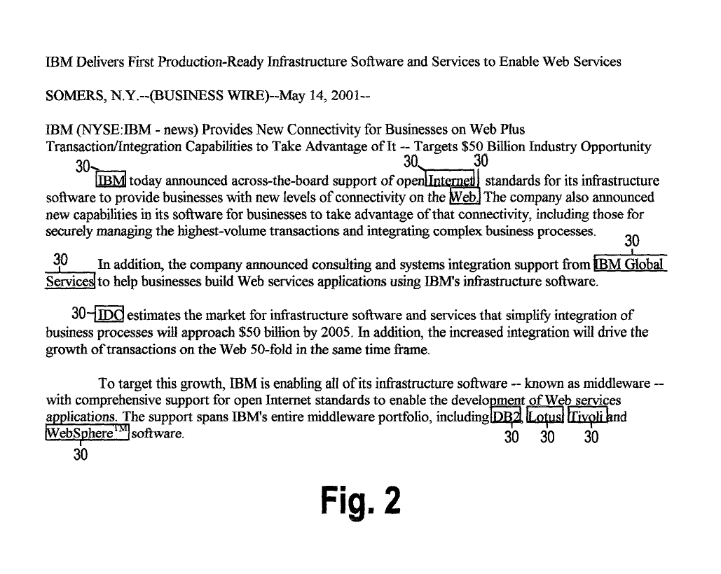

FIG. 2 illustrates the text of FIG. 1 with some anchor candidates (words or phrases) highlighted in accordance with rules which will be described later in this document. A plurality of words (or phrases) have been highlighted using a conventional technique for creating highlighting in text, in this case a rectangle drawn around the highlighted word or phrase. Each such highlighted words is indicated by the reference numeral 30 in this illustration. Other methods of highlighting portions of interest such as using one or more different colors to highlight the words could be used as desired, and different colors or symbols could indicated different reasons why a portion has been highlighted—a first color or symbol to indicate a word which is not in the dictionary, a second color or symbol to indicate a portion which includes a corporation identifier, a third color or symbol which indicates a trademark and a fourth color or symbol to indicate a word from a previously-compiled listing of trademarks or words used for hot links. The different symbols could be any indicator which would draw attention to one portion of text and differentiate it from the surrounding unemphasized text, and might include underscore, bolding, italicization, enlarged type or inclusion within brackets or braces rather than the rectangles or rectangular boxes described above and shown in FIG. 2. In some cases the highlighting may exist only within the program and be transparent to the reviewer so that the reviewer is not confused by the highlighting of portions other than the portion which the reviewer may be reviewing at any given time, and a program may include user controls to allow the visible highlighting of all highlighted portions to be invoked (turned on) or suppressed (turned off) on command by the reviewer.

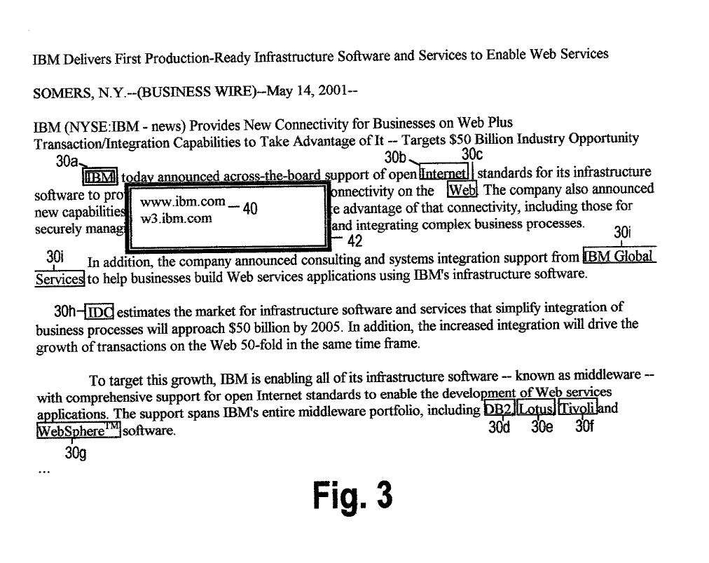

FIG. 3 illustrates the portion of text from FIGS. 1 and 2 with the highlighting as described in connection with FIG. 2 and further with a system for directing a reviewer's attention to a single one of the highlighted portions (anchor candidates) at a time. In this case, the text includes a plurality of highlighted portions or anchor candidates identified as 30a, 30b, 30c (and so forth) and the first highlighted portion or anchor candidate 30a is shown with additional emphasis as illustrated in this FIG. 3 by the shading on the rectangle. This indicates that the reviewer should look at this particular instance of the highlighted portions at this time. A dialog box 42 is shown in association with this highlighted portion 30a and includes one or more possible hot links 40 for the highlighted portion. This system of highlighting (as described later in greater detail) allows the reviewer to consider whether to include a hot link for each identified anchor candidate one at a time and, if multiple hot links have been identified for a given anchor candidate, to make a selection. The reviewer may indicate that no hot link is to be provided for a given anchor candidate or may indicate that the listed URL be used for the anchor candidate. Alternatively, the reviewer may indicated that another identified web site be used (if the system has identified multiple possible web sites) or that an alternate web site supplied by the reviewer be used for the anchor candidate by suitable key strokes which are recognized by the program. These key strokes are subject to design choices but may be the ESCAPE key for no web site, the ENTER key for selecting the first or only identified web site, a PAGE DOWN key for moving down the list of possible web sites until the appropriate web site is selected and typing in a different URL to indicates that the reviewer was supplying a web site rather than accepting a web site provided by the system.

Of course, any conventional method of highlighting a single anchor candidate of interest 30a and for including web site candidates for hot links can be used with the present invention. That is, the highlighted anchor candidate 30a could be indicated with a color of choice (for example, red) while the rest of the anchor candidates are shown in a different color (such as blue) and the text with words which have not been identified as anchor candidates shown in the conventional black type. Alternatively, the highlighted anchor candidate 30a of interest at any given time could be highlighted using enlarged type (e.g., 14 point rather than 12) and/or in bold or italic type to make the single anchor candidate under consideration stand out and command the reviewer's attention while providing the remainder of the text in readable form. The potential hot links could be shown in a dialog box adjacent the anchor candidate, if desired, or could be displayed in a margin of the document, either at the top, bottom or one side, to avoid interfering with the reviewer's reading of the surrounding text, since it may be desirable for the reviewer to review the text to determine whether a link should be included and which link should be chosen. Once a single anchor candidate has been processed, the system can focus on the next anchor candidate by de-emphasizing the processed anchor candidate and highlighting the next anchor candidate until all of the identified anchor candidates have been processed in the text.

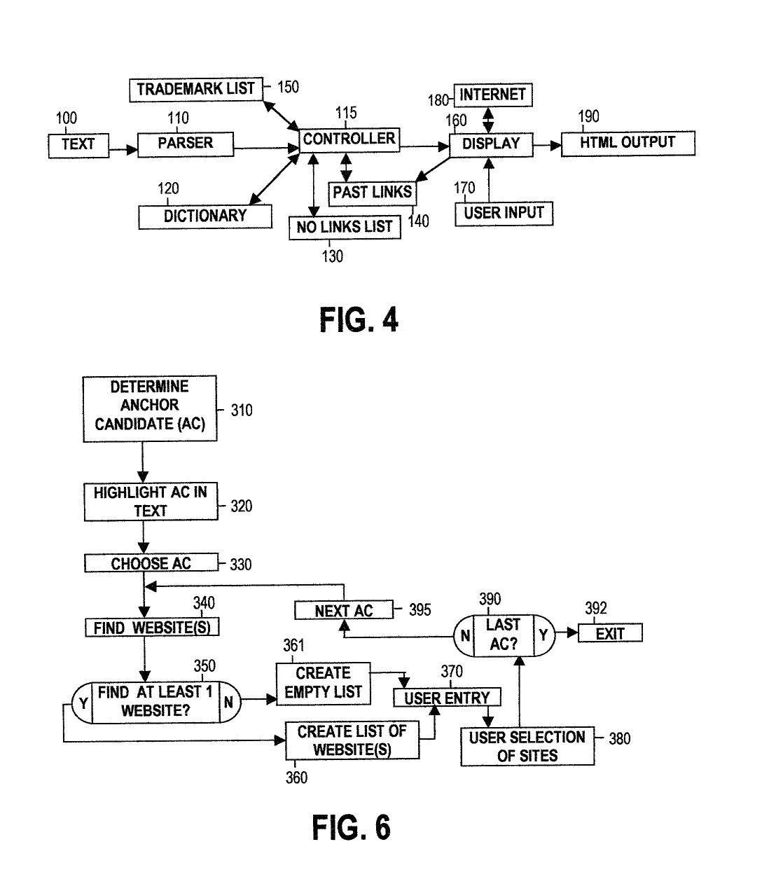

FIG. 4 is a block diagram for one embodiment of the present invention. As shown in this view, text 100 is fed to a parser 110 which identifies individual words to a controller 115. The controller 115 is shown connected to a dictionary 120, a “no links” list 130, a past links list 140 and a trademark list 150 for processing of each word identified. As a result of the comparisons with the dictionary 120, the “no links” list 130, the past links list 140 and the trademark list 150, the controller 115 generates and presents on a display 160 the text 100 with anchor candidates 30 identified. User input 170 (as described elsewhere in this document for processing the anchor candidates) is provided at block 170 and a connection to the Internet is illustrated by the block 180. The output 190 of this processing based on information from the Internet 180 and the user input 170 is a program including appropriate web site links in a format suitable for use in conjunction with the Internet, preferably in hypertext markup language (or HTML) with hot links activated according to the present invention, although other formats of output could be used to advantage, if desired, since the present invention is not limited to use of output generated in the HTML format.

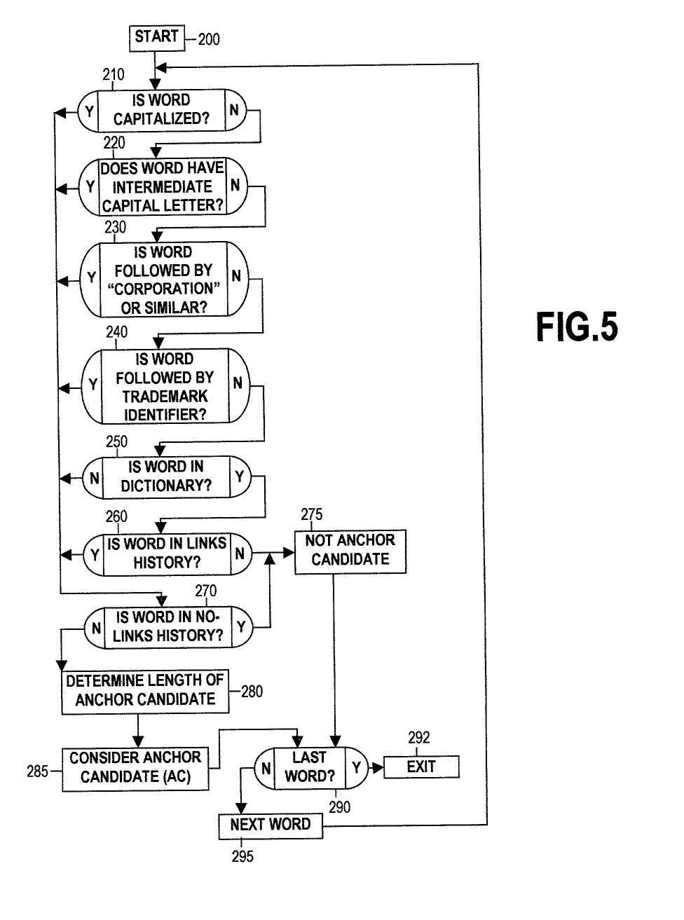

FIG. 5 illustrates a flow chart for one process of identifying anchor candidates from a text which is parsed into individual words as by the system of FIG. 3. Starting at block 200, the system first determines at block 210 whether the word begins with a capital letter, which may indicate that the word is a part of a corporation name, a trademark or a name of an individual or merely that the word is at the beginning of a sentence or capitalized for some other reason (in the German language, all nouns are capitalized, for example). A corporate name or a trademark are more likely to have an associated web site than the name of an individual and a word which is capitalized only merely because it is the first word in a sentence is probably not of interest as pointing to a web site. A trademark may be deliberately in a non-capitalized format, also. So the presence of a initial capital letter may or may not indicate a word which has an associated web site.

If a word has an initial capital, it is handled as a potential anchor candidate and processed at block 270 to determine if it is on a list of words for which no anchor candidate is to be found, even though it may be capitalized for some unrelated reason, such as being the first word in a sentence or being in a title where each word is capitalized. If a word does not have an initial capital, then at block 220 it is determined whether the word has an intermediate capital letter which may indicate a brand name (such as iMac)—and this could be expanded easily to include words which have either an unusual number (such as Lotus123) or punctuation (Yahoo!) which may indicate a made-up name which is likely to have an associated web site. If such an unusual characteristic is found, again the word is considered a possible anchor candidate. If not, then at block 230 whether the name is followed by a corporation indicating symbol such as “corporation”, “incorporated”, “company” or their abbreviation is determined, again indicating a potential anchor candidate if found. If not, a trademark identifier such as “trademark”, “registered” or a related abbreviation or symbol is determined at block 240 as an indicator for a possible anchor candidate. If the word is none of the foregoing, then it is tested against the dictionary at block 250, where words which are not in the dictionary (using an expanded dictionary, if available, as discussed elsewhere in this text) as possible anchor candidates. Even those words which are in the dictionary may have an associated web site (since some products or companies use common words as their symbol), so the next step is to check a listing of past links at block 260, links which may have been entered by hand or based on some indicator (such as a trademark symbol or a corporate name) which is not present in the text at hand.

Those words which have been determined to be a possible anchor candidate from the preceding tests are compared with a no-links history at block 270. The no-links history compares the current word with a listing of past activity of finding web sites where no web site was used, either because no associated web site was found or where the web site found was determined not to be used by a reviewer for whatever reason. If past attempts did not find a web site for a word or determined that the web site was inappropriate, then it is likely that the same result will be encountered on any subsequent occurrence.

If the word is not in the links history at block 260 or if it was found in the no-links history at block 270, then the word is determined not an anchor candidate at block 275. If the word was not determined to be in the no-links history at block 270, then the next step at block 280 is to determine the length of the anchor candidate at block 280. While some anchor candidates may be a single word, many trademarks and company names consist of multiple words and each of them need to be associated to find the proper link. For example, either IBM or Xerox may be a single word and useful as an anchor candidate by itself, but “International Business Machines” would be a useful anchor candidate while none of the component words individually would be useful because of the overwhelming number of sites which are associated with each. Similarly, trademarks are frequently several words, and it is desirable to look for the entire trademark as an anchor candidate rather than a piece.

Once the anchor candidate has been identified at block 285, then a search engine such as Yahoo!, Alta Vista or Dogpile.com can be used to search the Internet to find sites which are likely to be related to the anchor candidate in a process described in detail later.

Next, it is determined at block 290 whether this is the last word; if so, the process ends at exit 292, otherwise it proceeds to the next word at block 295 and repeats the process beginning at block 210.

Obviously, the order in which the tests of FIG. 5 occur is somewhat arbitrary, and these could be performed in another order, if desired, and some of the steps might not be included in every system. For example, a list of past links may not exist or may not be used for some applications and in others the no-links history may be skipped. Presumably, a word will not be in the past links list and the no links list at the same time, so those which are found in one need not be tested against the other. Also, in some instances, it may be desirable to find the words used as past links first to avoid the additional steps for those words which will be used as anchor candidates. In any event, it would be desirable to ask first the questions which have the greatest chance of identifying (or eliminating) an anchor candidate to reduce the amount of processing necessary.

In determining anchor candidates for a given text, it should be understood that any text is likely to include redundancies of the same word or phrase and the system or the reviewer must determine whether to include repeated hot links for repeated occurrences of the same word or phrase or to provide a link only on the first occurrence of each word or phrase. A decision may be made to include a hot link only for the first occurrence of the word or phrase, so then an additional list of previously-seen anchor candidates for each document is developed and checked for duplication to avoid the inclusion of multiple hot links to a single word or phrase. That is, when an anchor candidate is identified for a document, it is written on a list of anchor candidates and that subsequent anchor candidates are compared to that list of previously-identified anchor candidates for that document before highlighting the candidate in the text.

FIG. 6 illustrates the processing involved in the preferred embodiment after an anchor candidate has been identified in FIG. 5. Once an anchor candidate (AC) is identified using a process such as was described in connection with FIG. 5 at block 310, the anchor candidate AC is highlighted in the text by a suitable technique such as enclosing it within a box (as an alternative, the anchor candidates could be highlighted in the display in a different color from the surrounding text which is not an anchor candidate) at block 320. Next one of the anchor candidates AC is selected for processing at block 330 and relevant web site(s) related to that anchor candidate AC are displayed at block 340. These relevant web site(s) may be found using a search engine such as Google, Alta Vista, Yahoo!, Ask Jeeves, or other general purpose (or special purpose) search engines or may result from consulting private databases or past history, or some combination of these. If there is at least one web site located through the technique(s) described at block 350, then block 360 creates a list of the web site(s); if not, at block 361 an empty list is created. Next, at block 370, an area where the user is prompted to insert a web site or provide a different word on which to seek a relevant web site is added to the list of proposed web sites from block 360 or 361. At block 380, the user selects from the list of web sites and entry areas created at block 370, selecting one or more web site(s) or no web site. Following the processing at block 380, next it is determined whether this anchor candidate is the last at block 390. If so, the process exits at block 392, if not, the next anchor candidate is identified at block 395 and the process from block 340 using the new anchor candidate AC. Usually the process would begin at the beginning of the document and display the first located anchor candidate for processing, then the next one until the last anchor candidate has been processed, although another order could be used, if desired, such as processing the anchor candidates in the main text first. Further, it may be determined that no anchor candidates would be considered from certain sections of text, for example, the index or table of contents or text imported from another source.

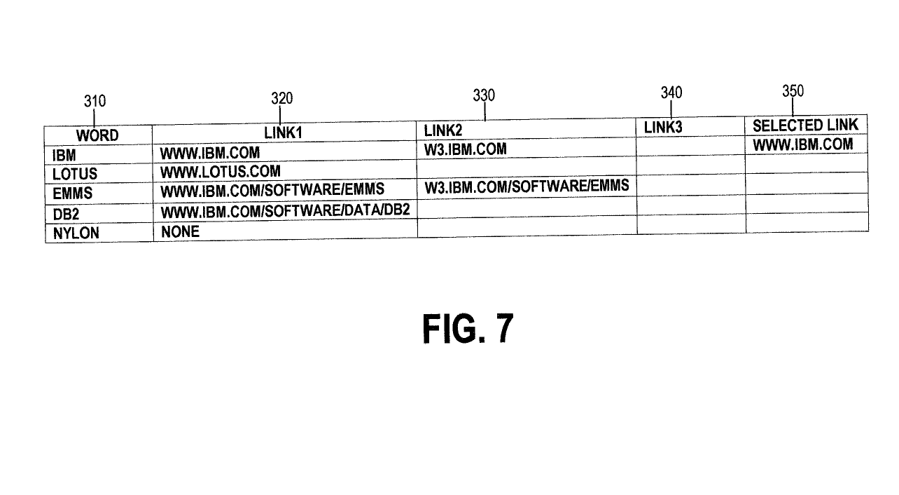

FIG. 7 illustrates a table of link histories from processing of past anchor candidates, either in general or in connection with the present text. In this table, the word (or words) from the text are included in the word column 310, then link columns 320, 330, 340 lists the links which have been found for the text. In addition, a column 350 is provided for links which were selected by the user in connection with the search. In connection with a first entry of IBM as a word from text, first link column 320 indicates a first link “www.ibm.com” and a second link column indicates the link “w3.ibm.com” (an Intranet link). The selected link column 350 indicates that the link “www.ibm.com” was chosen at some point in the past for this word. Other words in the list (Lotus and DB2) have been listed with the associated web sites and a word “Nylon” has been listed as a word for which it was determined that no web site would be listed on a past occurrence, indicating that, although web sites could be used, no web site was selected.

The history might be a running list of web sites, both located through searching and supplied by an individual upon review, and this list might be kept cumulative (in the case of a single client with many pages of related text) or it may be purged after each use (in the case of an advertising agency or an independent programming shop which uses the present invention for a plurality of unrelated clients).

The present invention may be implemented in a computer such as a general purpose processor with suitable software. It may also be implemented through the use of a specialized processor which is configured to do the processing described in connection with the previous description. The present invention can be realized, according to the designer's interests, in hardware, software, or a combination of hardware and software. An image processing system according to the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein. Relevant portions of the present invention can also be embedded in one or more computer program products, which comprise at least selected portions of the features enabling the implementation of the methods described herein, and which—when loaded in a computer system—are able to carry out these methods.

Software and computer program are used interchangeably in this document. Software in the present context means any expression, in any language, code or notation, of a set of instructions intended to cause a system having an information processing capability to perform a particular function either directly or after either or both of the following a) conversion to another language, code or notation; b) reproduction in a different material form.

The present invention obviously may be implemented in the form of software which is either available as a program product or the use of which is available over a network such as the Internet. The present invention also contemplates that a service might be offered to assist in including appropriate links to web sites in software which creates web sites. Such software or service may provide all of the functions of the foregoing software or may include a predetermined link (or links) in lieu of having a knowledgeable individual determine whether to include web sites for a word or phrase or not, since the service or the software may not have a knowledgeable person available to provide this input. In any event, such software or services are a first step to creating software for a web site with the appropriate hot links.

When multiple sites are identified, they can be presented in an ordered list, based on some parameter. One parameter which is available is a likelihood of the site matching the input, based either on the word or phrase entered or on the context of the text as a whole or its immediate location as compiled by a web search engine such as Yahoo!, Alta Vista or Google. Another basis for determining which sites to list and in which order may be based on the compensation which is provided by the web site, either directly (a cash payment for referring browsers to a site) or indirectly (a web site which refers browser to your web site may be favored over a web site which does not refer browsers to you). In addition, a web site which is owned or controlled by the party creating the copy may be preferred over a web site which is not controlled, and an Internet site may be preferred over an Intranet site in some instances (such as content directed to the general public), while in other situations (internal use sales literature, for example, intended for a company's employees), the Intranet site may be preferred.

Of course, many modifications of the present invention will be apparent to those skilled in the relevant art in view of the foregoing description of the preferred embodiment, taken together with the accompanying drawings and the appended claims. For example, the method of highlighting an anchor candidate is obviously subject to design choice. The creation of web sites in the hypertext markup language (or HTML) is preferred in the present embodiment, but the present invention would work well using other languages and other conventions for including reference to web sites and is, accordingly, not limited to the environment of HTML programming. Further, in some circumstances, some of the features might be omitted without impacting the spirit of the invention, such as the personal input to select web sites. Additionally, some elements of the present invention can be used to advantage without the corresponding use of other elements. For example, the provision of allowing a choice between multiple web sites is a desirable but not essential element of the present invention and a system which identifies a single web site for possible inclusion is certainly within the purview of the present invention. Also, a system which allows for a different web site to be supplied when a wrong web site is located is desirable but not essential to the present invention. Further, various other devices could be added to the present invention or substituted for some of the described components to advantage depending on the environmental circumstances. Also, in some cases it may be possible and desirable to prioritize the several sites which are identified for a particular anchor candidate, for example, by choosing the site which has been updated most recently or in choosing the site which includes key words in common with the text being parsed, a feature which would add to the usefulness of the present invention Accordingly, the foregoing description of the preferred embodiment should be considered as merely illustrative of the principles of the present invention and not in limitation thereof.

Having thus described the invention, what is claimed is:

1. A method of creating at least a part of the code for establishing a web site using text which includes content for the web site, the steps of the method comprising;
scanning the text and identifying words which are not in a standard dictionary;
using those words to locate one of more web sites which are related to those words which are not in a standard dictionary; and
if a web site is located, determining whether to include the web site located as a hot link within the created web site and, if so, including a hot link within the code to the web site.

2. The method of claim 1 wherein the step of determining whether to including the web site located in the method of creating a web site further includes the step of receiving an input from an operator which indicates whether to include a link to a web site.

3. The method of claim 2 wherein the method of creating a web site including the step of determining whether to include a link to a web site includes determining which of multiple web sites to include.

4. The method of creating a web site including the steps of claim 1 wherein the method further includes the step of consulting a table of previous links and determining that a site has been previously identified for a particular portion of text.

5. The method of claim 1 wherein the method further includes consulting a listing of words for which no web site will be included within the created web site.

6. A system which creates at least part of the code for a web page having integrated hot links from a text, the system comprising:
an editing system which creates software implementing a web page including the text;
a dictionary of common language words;
a parser for separating the text into words;
a comparator which is coupled to the dictionary and the parser compares at least some of the words in the text with the dictionary of common language words and determines which words are not included in the dictionary;
a system which determines web pages which are associated with a word which is in the text but which are not included in the dictionary;
a system which presents to a reviewer a word which is in the text but which is not in the dictionary along with at least one associated web page if one has been determined to be associated with the word; and
a system which allows the reviewer to include in the web page an integrated hot link to a web page which is associated with the word.

7. A web site creation system of the type described in claim 6 wherein the system includes the capability for displaying more than one web site which may be associated with the word and which allows the reviewer to select the web site which is included in the web page from the more than one web site which is displayed.

8. A web site creation system of the type described in claim 6 wherein the dictionary includes augmenting rules to consider variations of dictionary words as a part of the dictionary, whereby words which included in the dictionary in somewhat altered form are considered as in the dictionary for the purpose of determining words which are not in the dictionary.

9. A web site creation system of the type described in claim 6 wherein the system further includes a system which recognizes at least one symbol associated with one or more words which suggests that a web site may exist for the one or more associated words and includes a system which determines whether a web site exists for that one or more associated words.

10. A web site creation system of the type described in claim 9 wherein the recognized symbol is a trademark-indicating symbol.

11. A web site creation system of the type described in claim 9 wherein the recognized symbol is a corporation-indicating symbol.

12. A web site creation system of the type described in claim 6 wherein the system further includes a listing of past web sites which have been included in a web page in response to the detection of a listed word in the text and an anchor candidate is indicated when the listed word is detected in the text.

13. A web site creation system of the type described in claim 6 wherein the system further includes identification of anchor candidates for which no web site was associated and a mechanism which allows an entry by a user for such anchor candidate.

14. A system which creates at least part of the code for a web site comprising:
a parser which separates text into words and phrases;
a system which compares the words and phrases with entries for which a web site is available and generates an output indicating one or more web site associated with one of the words and phrases;
a system which receives a user input indicating whether a web site should be associated with a word or phrase and which one or more of the web sites should be associated with the word and phrase; and
an editing system which generates a web site for the text which includes a hotlink for the web site(s) indicated by the user input.

15. A web site creation system of the type described in claim 14 wherein the system which compares the words and phrases includes a web search engine.

16. A web site creation system of the type described in claim 14 wherein the system which compares the words and phrases includes a dictionary.

17. A web site creation system of the type described in claim 16 wherein the system which compares the words and phrases includes a dictionary which is augmented by rules which identify other related words which are considered a part of the dictionary.

18. A web site creation system of the type described in claim 14 wherein the system which compares words and phrases includes a system which recognizes indications contained in the test of a trademark as an indicator of an associated web.

19. A web site creation system of the type described in claim 14 wherein the system which compares words and phrases includes a system which identifies a corporate name in the text as an indicator of an associated web site.

20. A web site creation system of the type described in claim 14 wherein the system which compares words and phrases includes a mechanism which recognizes capitalization as an indicator of a word possibly associated with a web site.

21. A web site creation system of the type described in claim 20 wherein the mechanism which recognizes capitalization as an indicator includes a component which identifies capitalization which occurs within a word as an indicator.

22. A stored program for creating at least part of the code for a web site based on a text, the stored program comprising:
a program component which identifies a portion of the text for which a web site may exist;
a program component which seeks to locate one or more web sites for the identified portions of text;
a program component which displays the one or more located web sites which are associated with an identified portion of the text;
a program component which responds to a user input to select whether to include a web site and, if more than one web site is identified, to select which web site or web sites will be included; and
a program component which creates a web site based on the text and includes a hot link to the one or more web sites which were selected by the user.

23. A stored program of the type described in claim 22 which further includes a dictionary which is associated with the program component which identifies a portion of text for which a web site may exist.

24. A stored program of the type described in claim 22 which further includes a system which recognizes capital letters in a word as an indication of words with which web sites may be associated.

25. A stored program of the type described in claim 24 wherein the system which recognizes capital letters is responsive to unusual capitalization as an indication of a word associated with a web site.

26. A stored program of the type described in claim 22 wherein the system which identifies words which may be associated with web sites further includes a system which is responsive to identification of trademarks.

27. A stored program of the type described in claim 22 wherein the system which identifies words which may be associated with web sites further includes a system which is responsive to identification of corporation names in the text.

28. A method of using text to create at least part of the software to implement a web site comprising the steps of:
scanning the text and identifying one or more words in the text as possibly relating to another web site;
identifying one or more web sites which relate to the one or more words identified in the text;
displaying the one or more web sites which relate to the one or more words identified in the text; and
creating at least one pointer in the software to one of the web sites displayed.

29. A method of creating software including the steps of claim 28 wherein the step of displaying the one or more web sites includes the step of providing a list of web sites associated with the one or more words.

30. A method of creating software including the steps of claim 28 wherein the method further includes the step of creating and embedding in the software a hot link for a web site.

31. A method of creating software including the steps of claim 28 wherein the step of identifying one or more words includes the step of comparing one or more words with entries in a dictionary and selecting one or more words which do not have an entry in the dictionary.

32. A method of creating software including the steps of claim 28 wherein steps of the method further includes using an analysis system for choosing a web site.

33. A method of creating software including the steps of claim 32 wherein the step of using an analysis system includes employing a web search engine.

34. A service which receives text and creates at least a portion of the software with embedded hot links based on the text, the service comprising:
parsing the text and determining one or more sets of one or more words in the text, but less than the entire text, which are candidates for identifying a web site;
determining whether a web site is associated with one set of one or more words which has been determined; and
including an embedded hot link in the software for the one set of one or more words in the text which has determined to have a web site associated with the words.

35. A service including the elements of claim 34 wherein the step of determining one of more sets of one or more words is based on at least one of look up in a dictionary and use of a search engine.

36. A service including the elements of claim 34 wherein the step of determining one or more sets of one or more words is based on identifying a trademark indicator in the text.

37. A service including the elements of claim 34 wherein the step of determining one or more sets of one or more words is based on identifying a corporation indicator in the text.

38. A service including the elements of claim 34 wherein the step of including an embedded link includes the step of including more than one link for a set of one or more words when more than one link is determined to be associated with the set of one or more words.
